(19) United States
(12) Patent Application Publication
(10) Pub. No.: US 2022/0354102 A1
(43) Pub. Date: Nov. 10, 2022

(54) SHOEING MADE OF A FIBER-PLASTIC COMPOSITE, IN PARTICULAR FOR HORSES OR RACEHORSES

(71) Applicant: WINNER AG, Chur (CH)

(72) Inventors: Martin Zindel, Landquart (CH); Christian Lampert, Jenins (CH)

(21) Appl. No.: 17/739,049

(22) Filed: May 6, 2022

(30) Foreign Application Priority Data
May 6, 2021 (CH) 00509/21

(51) Int. Cl. A01L 5/00; B29C 70/44

(52) U.S. Cl. CPC A01L 5/00; B29C 70/443

(57) ABSTRACT

A U-shaped shoeing for horses comprises a running surface and a hoof contact surface has reinforcing layers embedded in a plastic matrix. The reinforcing layers longitudinally extend and follow the U-shaped curvature of the shoeing. Reinforcing layers extend transversally to their longitudinal extension from the running surface towards the hoof contact surface. Reinforcing layers are arranged on the hoof contact surface side, parallel to the hoof contact surface, parallel to the hoof contact surface, or parallel to the hoof contact surface and penetrate in the matrix as far as below the hoof contact surface or form the hoof contact surface. The reinforcing layers may be in the form of textile tube structures produced from fiber strands containing a multiplicity of fibers. The invention also relates to a production method for such a shoeing.

### CROSS-REFERENCE TO RELATED APPLICATION

The present application claims priority to Swiss Patent Application No. CH00509/21 filed on May 6, 2021, the entirety of which is incorporated by this reference.

### TECHNICAL FIELD OF THE INVENTION

The invention relates to a shoeing for horses. The shoeing according to the invention is suitable for sport horses, in particular for racing horses.

### BACKGROUND OF THE INVENTION

The shoeing used most frequently in the past for racing horses usually consist of aluminum. This type of shoeing is relatively light (about 127 grams), but quite rigid and hard. The abrasion of the aluminum shoe is low. An aluminum shoe lasts about 5 weeks, after which the horse must be re-shod. This is especially the case because the hoof grows back. Metallic shoeing is quite rigid and hard overall. With regard to animal health, materials which better correspond to the properties of a horse's hoof would be desirable.

Alternatively, patent application US 2010/0276163 A1 proposes, among other things, a shoeing made of fiber-reinforced plastic, which protects the horse's hoof from abrasion and is relatively light.

The patent application CH 710762 A2 describes a shoeing for racing horses which, in the examples relevant to the invention, consists of a fiber-reinforced thermosetting plastic core (for example carbon-fiber-reinforced epoxy resin) which is coated with a layer of plastic, for example produced from a layer of thermosetting plastic or thermoplastic polyurethane resin. These shoes are quite light and should have a high strength and resistance due to the fiber-reinforced thermoset core. It could be shown that the effective racing performance of a horse increases due to the reduced weight of a shoeing reinforced with carbon fibers. However, it has been found that the shoeing often experienced unexpected cracks after a short time in use, as a result of which the shoeing became unusable and had to be replaced prematurely. In addition, depending on the training scope and ground conditions, it has been found that the wear was not optimal, which can shorten the life of the shoeing and impair the grip properties of the shoeing.

The patent application WO2018/205044 describes a showing made of fiber-reinforced thermoplastic polycarbonate for racing horses. In one injection molding method for producing a shoeing comprising a core consisting of a composite of carbon fiber and glass fiber in a matrix consisting of thermoplastic polycarbonate. The fibers reinforcing the core can form a meshing, a knitted fabric or a mesh and can be arranged in one or more layers. If several layers are present, the fiber alignment in the different layers is preferably different. In a preferred embodiment, the core comprises, for example in alternating sequence, mesh layers of carbon fibers and mesh layers of glass fibers which are bound into a thermoplastic matrix. On the other hand, it is disclosed that a thermoplastic polycarbonate material reinforced with two different short fiber materials is suitable as a full shoeing material even without the core described. This second alternative is particularly cost-effective. Furthermore, an abrasion protection insert is revealed which is embedded in the shoeing, for example a curved strip which is arranged essentially transversely to the running direction. The core and the abrasion protection insert may optionally be connected to one another.

The patent application DE 195 38 093 A1 describes a mechanically fastened hoof protection with a layered structure of spring steel strips or high-modulus fiber mesh. In this case, the bands are arranged with their width perpendicular to the floor or parallel to the hoof wall and in their longitudinal extent following the shape of the hoof edge. The bands can be embedded in deformable material, for example the spring steel bands or the high-modulus fiber mesh bands (such as Kevlar) in polyurethane plastic.

In many equestrian sports, especially in racing, where regular and intensive training places special demands on the hooves or their shoes, durable shoeing are a basic requirement for the sport to be able to operate at all. In addition to the resistance or durability of a shoeing, the performance of the animal is of particular interest in sports. Shoeing obtainable today are not optimal, in particular not for horse racing, since, on the one hand, they are not sufficiently resistant, in particular not crack-resistant, and/or adversely affect the performance of the horse, for example by virtue of excessively high weight, unfavorable hold on the ground, sliding properties and/or damping properties.

The alternative with fiber-reinforced core described in the patent application WO2018/205044 turned out to be more rigid and thus in principle more suitable than the alternative without the core described therein. Contrary to expectations, however, the following disadvantages occurred. In the case of the thermoplastic matrix-based embodiment with fiber-reinforced core, it was found that, owing to the brittleness of the core, a certain risk of breakage remains which cannot be eliminated by the thermoplastic matrix. On the one hand, it turned out that there was a risk of breakage, in particular due to impacts or fatigue of the material. On the other hand, the thermoplastic matrix was found to be too soft and thus too deformable in comparison with the core. Overall, an inadequate connection between the core and the matrix can be determined, which has a negative effect on the life of the shoeing.

### ADVANTAGES

It is therefore an advantage of the present invention to provide a shoeing for sport horses, in particular racing horses, with which the horses can achieve high running speeds. At the same time, even at high running speeds, running should be relatively energy-saving, so that even longer distances are possible at high running speeds. It is a further advantage of the present invention to eliminate the disadvantages mentioned at the outset to a great extent and to provide a hoof pad which is break-proof at low weight, has low abrasion and optimally dampens the horse's foot with each step (but without unnecessarily depleting the energy from the horse), in particular under racing conditions. Furthermore, it is an advantage to provide an alternative to aluminum shoes. In particular, it is an object of the present invention to provide an improved plastic-based material composite.

These and other advantages are achieved by the features of the independent claims. Further developments and/or advantageous embodiments of the invention are the subject matter of the dependent patent claims.

### SUMMARY OF THE INVENTION

This invention meets the above requirements in that it provides a shoeing, in particular a shoeing for horses or a shoeing with a characteristic U-shape, i.e. a U-shaped shoeing, which has a running surface and a hoof contact surface and which is constructed from a plastic matrix in which a multiplicity of reinforcing layers are embedded, the reinforcing layers each having a longitudinal extent and the reinforcing layers being arranged in such a way that their respective longitudinal extent essentially follows the U-shaped curvature of the shoeing, the shoeing being distinguished in that a plurality of the reinforcing layers are arranged in such a way that they extend transversely to their longitudinal extent essentially in each case from the running surface to the hoof contact surface.

The reinforcing layers, which are arranged in such a way that they extend transversely to their longitudinal extent essentially in each case from the running surface to the hoof contact surface, can be termed, in other words, essentially upright or perpendicularly aligned to the hoof contact surface.

According to an advantageous embodiment, a shoeing according to the invention has at least one plastic matrix in which a plurality of reinforcing layers in the form of sheet-like textile structures, such as textile bands, or three-dimensional textile structures, such as textile hoses, are embedded, following the curvature of the shoeing, essentially perpendicularly or, so to speak, standing to the hoof contact surface. Textile structures are, for example, meshes, woven fabrics, non-woven fabrics, knotted fabrics and knitted fabrics, meshes being particularly preferred. It is expedient for sheet-like textile structures to be in the form of bands or for spatial textile structures to be in the form of tubes. The reinforcing layers are particularly preferably in the form of meshes, in particular in the form of meshed bands and/or tubes.

The advantages of the shoeing according to the invention in contrast to hitherto known fiber composite shoeings are, for example, improved or optimized properties with respect to the abrasion behavior of the shoeings (abrasion resistance, roughness, slip resistance) and stress on the joints of shod animals (joint protection).

The further advantageous embodiment alternative listed below lead, alone or in combination with one another, to further improvements.

It is expedient for the reinforcing layers, which are aligned perpendicularly or upright with respect to the hoof contact surface, to be designed to be essentially curved in such a way that they follow the U-shaped curvature of the shoeing. It is also expedient for the reinforcement layers, which are aligned in a perpendicular or upright manner, to penetrate into the matrix essentially as far as below the running surface and, if appropriate, to partially form the latter. If the running surface is subjected to particular stress, the reinforcing layers can offer additional resistance to abrasion. The hoof contact surface can essentially be designed as a planar surface.

If the running surface has essentially two or at least two running next to one another (in particular essentially parallel next to one another), the U-shaped curvature of the shoeing shoes the following running surface ribs, between which a running surface groove runs, it is expedient for the reinforcing layers (or the reinforcing layers oriented perpendicularly or upright), which extend essentially in each case transversely to their longitudinal extent from the running surface (13) to the hoof contact surface (15), to be divided into at least one first group and a second group, at least one reinforcing layer (31, 31′) of the first group penetrating into the first running surface rib (21) in (or inside) the matrix and at least one reinforcing layer (33, 33′) of the second group penetrating into the second running surface rib (23) in (or inside) the matrix. Openings for horseshoe nails are intended to be in between the two running surface ribs, in particular in the running surface groove.

Optionally, at least one further one of the reinforcement layers can be aligned substantially parallel to the hoof contact surface. It is expedient for the uppermost of the reinforcing layers aligned parallel to the hoof contact surface to penetrate in the matrix substantially to below the hoof contact surface or to form the hoof contact surface. The at least one reinforcement layer aligned parallel to the hoof contact surface is spaced apart from the hoof contact surface in (or within) the matrix by the reinforcement layers aligned perpendicularly or upright to the hoof contact surface, i.e. the reinforcement layers extending transversely to their longitudinal extent essentially in each case from the running surface to the hoof contact surface.

The reinforcing layers may be in the form of band structures or tube structures. That is to say, the reinforcing layers can be produced from bands or tubes.

Advantageously, the reinforcing layers are formed essentially from fibers (fiber layers), in particular from flat fiber structures and/or three-dimensional fiber structures. Textile fiber structures are expedient. Fibers (or fiber layers) which, for example, form two-dimensional or three-dimensional structures, are preferably present in ordered textile structures, for example as a meshes, woven fabric, non-woven fabric, knitted fabric and/or knotted fabric. Meshes are preferred. The reinforcing layers, in particular reinforcing layers of braiding, woven fabric, non-woven fabric, knitted fabric and/or knitted fabric, are expediently penetrated by the plastic matrix in the finished hoof padding. The fibers are expediently essentially long fibers or continuous fibers.

It is particularly advantageous if the reinforcing layers are in the form of band or tube structures or if the reinforcing layers are produced by means of bands or tube bands or tubes which may be produced from fibers, meshed brands or meshed tubes. For the production of the shoeing, bands or tubes can be used which are structured or constructed in such a way that, when the band or tube is pulled apart in its longitudinal direction, the band or tube diameter or the band or tube cross section decreases and, consequently, that, when the band or tube is compressed (pushed together) in its longitudinal direction, the band or tube diameter or the band or tube cross section increases. Meshed bands or tubes can have these properties.

The reinforcing layers can be produced from flat fiber structures, such as, for example, ribbon structures or ribbons, or from three-dimensional fiber structures, such as, for example, tube structures or tubes. Tube structures may be preferred.

The reinforcing layers, or the tube structures or band structures, may be preferably in the form of textile structures which are essentially formed from fibers or may be from fiber strands. Textile structures can be present, for example, as meshes, woven fabrics, non-woven fabrics, knitted fabrics and/or knotted fabrics, meshes may be preferred.

Advantageously, the meshing, woven fabric, non-woven fabric, knitted fabric and/or knotted fabric is produced essentially from fiber strands (so-called rovings). A fiber strand (so-called roving) consists of a plurality of individual fibers or individual filaments. The individual fibers or individual filaments are expediently long fibers or continuous fibers. The fibers can be selected, for example, from the group consisting of carbon fibers (also called carbon fibers), polymer fibers such as, for example, aramid fibers (i.e. kevlar fibers), glass fibers and combinations thereof, aramid fibers may be preferred.

The material of the plastic matrix may preferably be thermosetting or a thermoset. In particular, a cured plastic resin system, for example produced from epoxy resin or polyurethane resin, is suitable as a matrix, epoxy resin systems may particularly be preferred. During the production process, the matrix material is normally crosslinked to such an extent during curing that it can no longer be substantially reshaped after curing (that is to say is cured to form the thermosetting plastic).

It may be expedient for the first group of vertically oriented reinforcing layers and/or the second group of vertically oriented reinforcing layers each to comprise at least 2, or at least 4, reinforcing layers layered side by side. This number of reinforcing layers can be obtained by embedding at least 1 tube or at least 2 tubes per group or at least 2 bands or at least 4 bands. It is assumed that each embedded tube forms a double layer, i.e., two reinforcing layers, so to speak. It may be particularly expedient to produce the first group of at least 4 reinforcing layers layered side by side and/or the second group of at least 4 reinforcing layers layered side by side on the basis of an embedding of at least 2 tubes layered side by side per group. Instead of the two tubes per group, four bands per group could alternatively be used for this purpose.

In another embodiment, the reinforcing layers are embedded meshed bands or tubes. Bands or tubes made of aramid fibers, i.e. meshed aramid bands or aramid tubes, may be particularly preferred.

It is advantageous if at least the reinforcing layers (or the reinforcing layers oriented essentially perpendicularly to the hoof contact surface or upright) extending transversely to their longitudinal extent essentially in each case from the running surface to the hoof contact surface are formed by one or a plurality of aramid bands or aramid tubes. It is also advantageous if the at least one reinforcing layer aligned parallel to the hoof contact surface is formed by one or more aramid bands or aramid tubes. Optionally, instead of one or more aramid bands or aramid tubes, the reinforcing layers aligned essentially parallel to the hoof contact surface or lying can be formed by one or more carbon bands or carbon tubes, aramid may be preferred, however, on account of its material properties.

In a particularly advantageous embodiment, the shoeing can be designed in such a way
that on the hoof-contact surface side, at least one further of the reinforcing layers is arranged in such a way that it is aligned essentially parallel to the hoof-contact surface, and that preferably the reinforcing layer may be aligned essentially parallel to the hoof-contact surface or the uppermost of the reinforcing layers aligned essentially parallel to the hoof-contact surface penetrates in the matrix essentially as far as below the hoof-contact surface or forms the hoof-contact surface, and
that the reinforcing layers are present as textile tube structures or as textile band structures, the textile tube structures or the textile band structures being produced from fiber strands, each fiber strand containing a multiplicity of fibers. Textile tube structures may be preferred over textile band structures.

In a further particularly advantageous embodiment, the showing can be designed in such a way
that the reinforcing layers are in the form of tube structures meshing from fiber strands (so-called rovings), and that each fiber strand of a meshed tube structure runs in a sequence alternately over fiber strands crossing it and under it through fiber strands crossing it, each fiber strand intersecting with the fiber strands crossing it in each case at a certain angle, all fiber strands simultaneously forming with the longitudinal direction of the tube a thread angle which corresponds essentially to half of the abovementioned certain angle.

Preferably, said certain angle is an acute angle, i.e. an angle smaller than 90 degrees. Particular preference may be given to an angle of less than 85 degrees, or more preferably an angle in the range of 46 degrees (in particular 46°±10°).

It is expedient for an abrasion protection element to be embedded in the plastic matrix, or at the center of the shoeing extension. For the purpose of improved slip resistance, it can be advantageous if the abrasion protection element rises at least partially from the plastic matrix on the running surface side (at least in the case of the freshly produced product). The abrasion protection element is expediently in the form of two curved webs which are arranged next to one another (in particular essentially parallel next to one another), follow the U-shaped curvature of the shoeing and may be preferably connected within the plastic matrix via a bridge. Advantageously, the abrasion protection element is bound into the shoeing by at least one reinforcing layer (i.e., for example, by at least one band or by at least one tube), which runs along between the webs of the bridge. This gives a shoeing with an embedded abrasion protection element particularly good durability and protection against tearing out of the abrasion protection element.

The plastic matrix can be sucked into the mold laid out with the layers by a vacuum pressing process, in particular by pouring the liquid precursor into a casting mold. The reinforcing structures can, for example, be inserted into the casting mold beforehand and are thus, if appropriate, impregnated when the matrix precursor is cast in.

A particularly advantageous production method for a shoeing described above may comprise at least the following steps:
Providing a tool mold with an essentially flat working surface, in which a cavity is formed which is shaped in the shape of the shoeing (i.e. curved in a U-shape) in the plane of the working surface. This cavity thus has its horseshoe-shaped contour in the working surface, the horseshoe shape, i.e. the U-shaped curvature of the cavity, being defined by inner contour walls.
Filling the cavity with a plurality of reinforcing layers, such as, for example, bands or tubes, in that these are inserted into the cavity in their longitudinal extent following the U-shaped curvature of the cavity and are aligned essentially perpendicularly to the working surface transversely to their longitudinal extent, i.e. in particular standing (or standing in their width). As a result, the reinforcing layers are arranged in the cavity in such a way that they extend transversely to their longitudinal extent essentially in each case from the running surface (13) towards the hoof contact surface (15).
Optional filling of the cavity with one or more further reinforcing layers, such as, for example, bands or tubes, in that these are laid out over the previously inserted reinforcing layers in such a way that they are likewise aligned in their longitudinal extent essentially parallel to the working surface, following the U-shaped curvature of the cavity.
Inserting of a plastic, in particular a hardening plastic system, into the cavity provided with said reinforcing layers.

Expediently, before a hardening plastic system is introduced into the cavity, the cavity is closed with a cover, as a result of which a mold cavity is produced.

The plastic or the hardening plastic system is expediently introduced by applying a negative pressure in the mold cavity, by applying an injection pressure or a combination of a negative pressure in the mold cavity and an injection pressure.

In order to introduce a plastic or a hardening plastic system into the cavity provided with said reinforcing layers, the cavity or the mold cavity is expediently evacuated, in particular after the cavity has been closed with a lid. As a result, a negative pressure or vacuum is generated in the mold cavity. The evacuation can serve to reduce or, as far as possible, to avoid air inclusions. If air inclusions in the material are reduced, the risk of breakage of the material can often also be reduced as a result.

Pin-like elevations can be arranged in the cavity, which serve to form nail holes in the shoeing to be produced.

An abrasion protection element can expediently be inserted into the cavity of the mold. Advantageously, a depression for receiving the abrasion protection element can be formed in the cavity. Insofar as this depression is present on the running surface side, the abrasion protection element in the finished shoeing can project beyond the running surface and thereby additionally offer support, in particular in order to avoid slipping after recent shoeing.

The abrasion protection element can expediently be fixed in the cavity, and in certain embodiments on at least one or two elevations, so that it does not slip when the mold cavity is filled. In practice, for example, the elevations which are provided for forming nail holes in the shoeing and are thus present anyway can be used for this purpose. In this case, the abrasion protection element expediently has structures, such as, for example, hole structures, by means of which the abrasion protection element can be plugged onto the elevations for shaping the nail hole.

The further advantageous embodiment alternative listed below lead, alone or in combination with one another, to further improvements.

### BRIEF DESCRIPTION OF THE DRAWINGS

Further advantages and features of the shoeing according to the invention can be gathered from the following description of an exemplary embodiment of the invention with reference to schematic representations. Said features can be implemented in any desired combination, insofar as they are not mutually exclusive. In a schematic representation which is not true to scale, the following are shown:

FIG. 1: a hoof-side view of a general shoeing;

FIG. 2: a running-surface side view of a general shoeing;

FIG. 3: a combined view and cross-sectional view of a shoeing with running-surface side profiling;

FIG. 4: a view of a cross-section of an embodiment of a shoeing according to the invention, such as is present in the middle of the shoeing by way of example (that is to say at the interface B-B of FIG. 3) or can be present in a similar manner as far as into the leg end regions;

FIG. 5: a view of a cross-section of an alternative embodiment of a shoeing according to the invention, such as is present in the middle of the shoeing by way of example (that is to say at the interface B-B of FIG. 3) or can be present in a similar manner as far as into the leg end regions;

FIG. 6: Abrasion protection in perspective view;

FIG. 7: Abrasion protection in three views;

FIG. 8: a shoeing according to the invention with an abrasion protection insert in three views;

FIG. 9: an example of a tube meshing, (a) under or after tension in a compact state, (b) in a slightly compressed state.

### DETAILED DESCRIPTION OF THE FIGURES

In the following, identical reference numerals stand for identical or functionally identical elements in identical or different figures.

In the following, a horseshoe for horses in general and a horseshoe according to the invention are described. Shoeing for horses is in particular a hoof protector which is fastened to the horse's hoof, in particular from the underside of the hoof, on the hoof wall by means of a multiplicity of nails and/or by means of an adhesive.

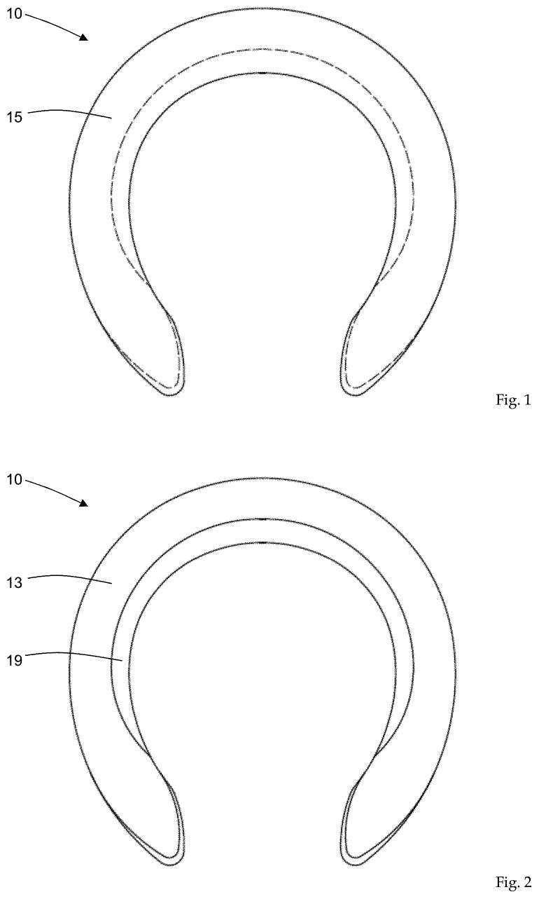

FIGS. 1 and 2 show a general schematic representation of a shoeing 10 in an upper view (FIG. 1) and a lower view (FIG. 2). In the top view (FIG. 1), the shoeing 10 can be seen from the hoof contact surface 15, i.e. from above. In the bottom view (FIG. 2), the shoeing 10 can be seen from the running surface 13, i.e. from below. A typical shoeing 10 is bent in a partially annular or U-shaped manner with two lateral legs running out to the rear and a front region pointing in the running direction and connecting the legs. A shoeing has two essentially U-shaped sides facing away from one another. The first is the running surface 13, the second is the hoof contact surface 15. An essentially circumferential wall essentially transfers from the U-shaped running surface 13 to the U-shaped hoof contact surface 15. The wall is essentially divided into an outer side of the fitting 17 and an inner side of the fitting 18. The running surface 13 can have a smaller width than the hoof contact surface 15 in the U-shaped course, for example in that the inner side 18 of the shoeing is designed at least partially as a surface 19 which recedes in a concave curvature from the running surface 13.

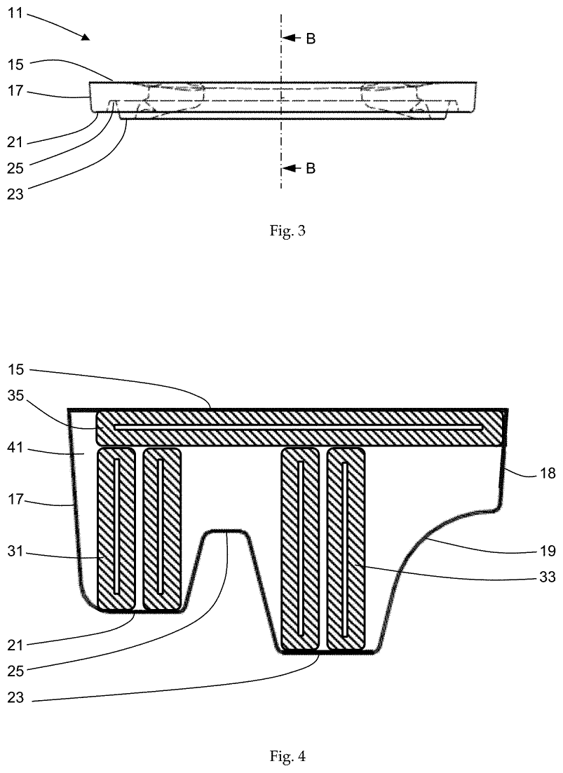

The running surface 13 is usually profiled, for example in the case of shoeings to be fastened with nails, at least in the sense that depressions and openings are provided for hoof nails. In an example described here, a running surface profile is shown in the cross-sectional view of FIG. 3. Here, a groove 25, which follows the U-shaped course of the running surface extension, divides the running surface 13 essentially into two ribs, which likewise run parallel in a U-shape, in particular an inner rib 23 and an outer rib 21. The inner rib 23 can be made higher on the running surface side than the outer rib 21 or projects beyond the outer rib 21, so to speak. An advantage of such a difference in rib height is that a certain amount of rolling is possible during running. In addition, such a profiling can improve the hold on the substrate as a function of the soil properties. Openings for setting hoof nails can be provided in the furrow 25. In this case, inserted nails may be sunk into the furrow 25, in particular essentially under a 23 imaginary line or surface connecting the two profile heights of the ribs 21, up to which line or surface hoof nails can normally be driven in.

The shoeing according to the invention consists of a fiber-plastic composite, reinforcing layers produced from fibers being embedded in a plastic matrix and being penetrated by the latter. The layers are expediently textile layers, particularly meshes. Layers and matrix in the composite improve and/or reinforce the respective material properties with regard to use as a shoeing. The type and manner of the spatial layer arrangement has proven to influence properties. Advantageously, the layer arrangement according to the invention permits a certain degree of spreading of the shoeing as a function of the load (for example, in the case of transverse accelerations of the horse, such as occur in curves). At the same time, a shoeing according to the invention resists the side pressures produced during use.

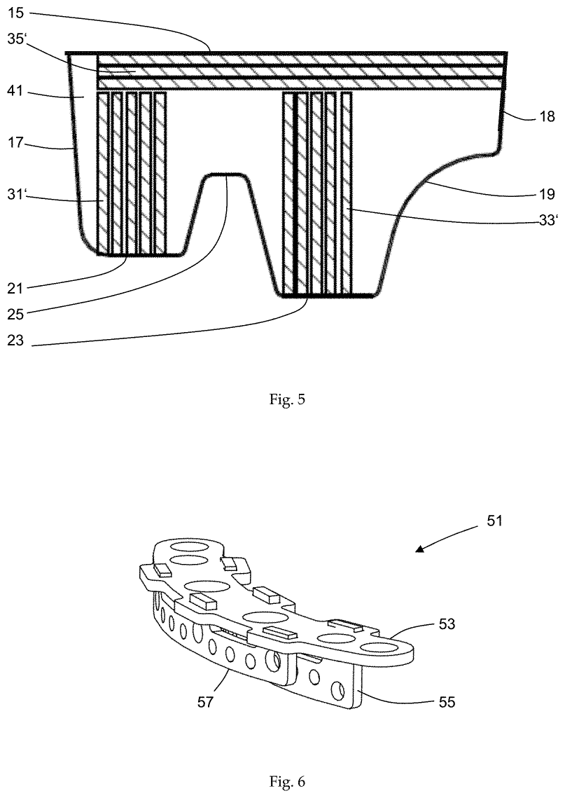

FIG. 4 and FIG. 5 each schematically show an example of a shoeing cross section according to the invention with layer structures embedded in the polymer matrix 41. This view is a cross-section of a shoeing according to the invention, such as is present, for example, in the middle of the shoeing (at the interface B-B of FIG. 3) or can be present in a similar manner as far as into the leg end regions. In particular, reinforcement layers 31, 31′ and 33, 33′ are embedded in the polymer matrix 41 on the one hand in an approximate or essentially perpendicular orientation to the hoof contact surface 15 and on the other hand in reinforcement layers 35, 35′ in an essentially parallel orientation to the hoof contact surface 15. Reinforcing layers are thus arranged in groups which can be distinguished from one another. The perpendicular to the hoof contact surface 15 oriented reinforcing layers 31 and 33 as well as 31′ and 33′ are forming a first group. The parallel to the hoof contact surface 15 oriented reinforcing layers 35 as well as 35′ are forming a second group. The first group of reinforcing layers reinforces the shoeing overall on the running surface side, in that the reinforcing layers 31 and 33 as well as 31′ and 33′ penetrate up to the running surface or form the running surface profile, while the second group of reinforcing layers reinforce the shoeing on the hoof side, in that the reinforcing layers 35 as well as 35′ of the hoof contact surface. It can be said that, viewed over the cross section of the shoeing, the first group of reinforcing layers 31 and 33 as well as 31′ and 33′ are essentially embedded and a second group of one or more reinforcement layers 35 as well as 35′ are essentially embedded. Both groups thus differ in the alignment and local arrangement of the layers as viewed over the cross section. In their longitudinal extension, all the reinforcing layers, i.e. the standing layers, 31, 33 as well as 31′, 33′, as well as the horizontal layers, 35 as well as 35′, adapted to the curvature of the shoeing or following it in a U-shaped curvature. Standing means in particular that the reinforcing layers 31 and 33 as well as 31′ and 33′ are arranged in such a way that they each extend transversely to their longitudinal extent predominantly from the running surface towards the hoof contact surface or in the direction of the hoof contact surface. Lying down in this case means, in particular, that the reinforcing layers 35 as well as 35′ are arranged in such a way that they are arranged predominantly in each case parallel to the hoof contact surface or extend substantially in each case parallel to the hoof contact surface.

The second group of reinforcement layers 35 as well as 35′ adjoins the hoof contact surface 15 in a surface-parallel alignment. In this case, the uppermost reinforcing layer of the group essentially forms the hoof contact surface 15.

The first group of reinforcement layers 31 and 33 as well as 31′ and 33′ penetrates by means of the longitudinal edge regions of the reinforcing layers as far as the running surface or, in particular, into the running surface ribs 21, 23. In this case, the longitudinal edges of a first part of the first group of reinforcing layers 31 as well as 31′ essentially the front, i.e. outer, rib 21 and the longitudinal edges of a second part of the first group of reinforcing layers 33 as well as 33′ essentially the rear, i.e. inner rib 23. Thus, following the U-shaped curvature of the shoeing and thus following the U-shaped curvature of the respective rib, the longitudinal layer edges run parallel to the ribs within the respective ribs 21, 23. Overall, the longitudinal edge regions of the reinforcing layers 31 and 33 as well as 31′ and 33′ are forming the essential parts of the running surface 13. A first part of the group of perpendicular to the hoof contact surface 15 oriented to reinforcing layers 31 as well as 31′ extends within the outer rib 21 or forms the outer rib 21 and a second part of the group perpendicular to the hoof contact surface of reinforcing layers 33 as well as 33′ extends within the inner rib 23 or forms the inner rib 23. Overall, the vertically oriented (i.e., the upright) reinforcing layers form and/or support the ribs 21 and 23.

The illustrations shown in FIGS. 4 and 5 with regard to the distribution and arrangement of the layers are merely an incomplete, schematic representation. Layer-free regions are not as pronounced in practice as shown in FIG. 4 and FIG. 5 or are not present at all. On the basis of the production process presented further below, the reinforcing layers are instead distributed over the width of the cross-sectional extent available. In particular, the layer edge regions embedded in the ribs are distributed over the respective available rib width, while the layer edge regions, which are essentially directed opposite thereto and are embedded in the vicinity of the hoof contact surface, are distributed over the available total width from the outer side of the fitting 17 to the inner side of the fitting 18. The two subgroups of reinforcing layers, which form the outer rib 21 or the inner rib 23, are in practice not necessarily spaced apart from one another near the hoof contact surface (as appears in the schematic representation), but the reinforcing layers fill or distribute themselves over the entire shoeing cross section from the outer side 17 of the pad to the inner side 18 of the pad in a regular row of the reinforcing layers, the layer portions in the ribs (or near the running surface 13) being packed relatively close to one another, while the layer portions can be packed together to a lesser extent and can be distributed over the width of the cross section.

The reinforcing layers 31, 33, 35 as well as 31′, 33′, 35′ are composed of textile structures. Such ordered textile structures may be, for example, meshed, woven, non-woven, knitted, knotted, etc. Reinforcing layers may consist of meshed layer structures. Suitable textile structures are obtainable, for example, as bands or tubes. To produce a shoeing according to the invention from a fiber-plastic composite, such bands or tubes can be inserted into a horseshoe-shaped cavity and then embedded in a plastic matrix. This results in shoeing structures as shown here with reference to FIG. 4 and FIG. 5.

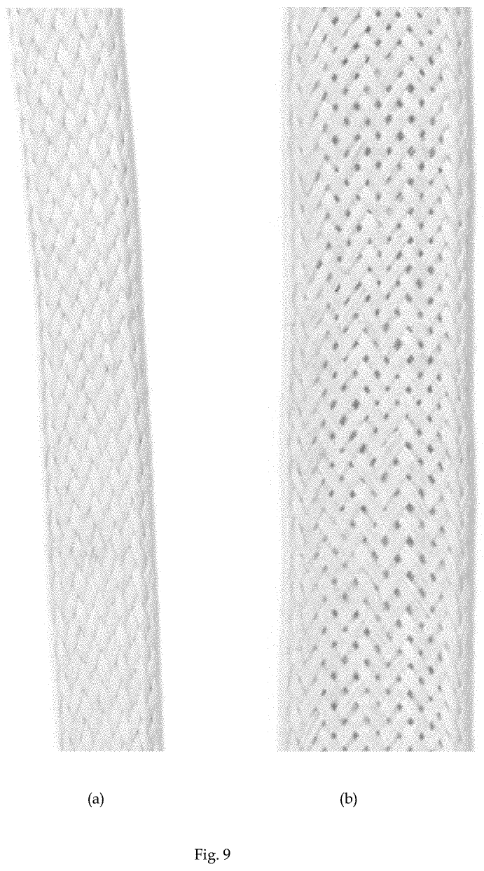

In order to produce an embodiment according to the invention (similar to that shown schematically in FIG. 4), textile tubes 31, 33, 35, for example, are inserted into a shoeing mold, virtually in the form of double layers, so to speak, in a flat-pressed embodiment. FIG. 9 shows, for example, a meshed tube. The tube is meshed from fiber strands (so-called rovings). Each fiber strand consists of a multiplicity of fibers, in particular essentially long fibers or continuous fibers. The fiber material used in the tube is expediently essentially inextensible or incompressible. In the meshing shown here, each fiber strand runs in a sequence alternately over two fiber strands crossing it and under two fiber strands crossing it, the said fiber strand intersecting with the fiber strands crossing it in each case at a certain angle, all the fiber strands simultaneously forming with the longitudinal direction of the tube an angle (i.e. thread angle) which corresponds approximately to half of the abovementioned certain angle. Said certain angle may be an acute angle, i.e. an angle of 90 degrees or less than 90 degrees, or an angle of less than 85 degrees, or an angle in the range of 46 degrees (in particular 46°±10°). Accordingly, the thread angle may be 45 degrees or less than 45 degrees, or an angle of less than 42.5 degrees, or an angle in the range of 23 degrees (in particular 23°±5°).

Tubes meshed in this way are distinguished, for example, by the fact that the tube diameter increases when the tube is pushed together along its longitudinal axis, in that the fiber strands move away from one another, or decreases again when drawn lengthwise (FIGS. 9 (a) and (b)), in that the fiber strands nestle against one another until the maximum packing density is reached. Under tension, the described tube mesh forms a particularly dense and stable structure. In the case of a tube mesh of the type described, the above-mentioned certain angle decreases with increasing longitudinally directed tension. The band or the tube is meshed in such a way that its diameter increases or decreases when pushed together or pulled apart, although the fiber material or thread material from which the band or the tube is made is itself essentially inextensible or compressible.

The fibers are processed into a mesh. The fiber-plastic composite is thus a plastic reinforced with meshed layers, in particular meshed bands or meshed tubes.

The fiber-plastic composite contains fibers which are expediently selected from the group consisting of carbon fibers, polymer fibers such as, for example, aramid fibers (for example kevlar fibers), glass fibers and combinations thereof. Aramid fibers are used because they achieve a shoeing which, on the whole, exhibits little abrasion and, at the same time, good impact resistance, that is to say is particularly resistant.

The matrix material is selected from a resin which can be converted into a thermosetting plastic. The material for the plastic matrix is in particular selected from the group of epoxy resins or cross-linkable polyurethanes. Preference is given to an epoxy resin which can be cured, in particular, to give the thermosetting plastic. The shoeing thus consists of a fiber-reinforced thermosetting plastic, i.e. reinforcing layers of fiber material embedded in a thermosetting plastic matrix.

Thus, a particular embodiment of a shoeing according to the invention contains a layering of tubular fiber mesh structures (in particular aramid fiber meshing) in a thermosetting plastic matrix (in particular thermosetting epoxy resin matrix), the tubes being embedded, following the U-shaped curvature of the shoeing, essentially standing flat in relation to the running surface and forming the running surface. In at least one group of at least four stratified tubes, the tube stratification has a stratification normal which is aligned essentially parallel to the hoof contact surface over the entire course of the extension of the tubes along the U-shaped curvature of the shoeing.

In one embodiment, the tubes consist of meshed fiber strands (FIG. 9). A fiber strand (also called roving) typically consists of 1000 to 3000 individual fibers (also called individual filaments). The tubes may be meshed with a thread angle of less than 45 degrees, that is in the range of about 23 degrees (in particular 23°±5°) (FIG. 9 (a)). Carbon tubes can also be used together with the aramid tubes.

In one method, the shoeing is produced in a vacuum pressing method, wherein fiber structures are placed in a prefabricated U-shaped negative mold and the plastic matrix is produced by introducing a hardening plastic or a hardening plastic system mixture.

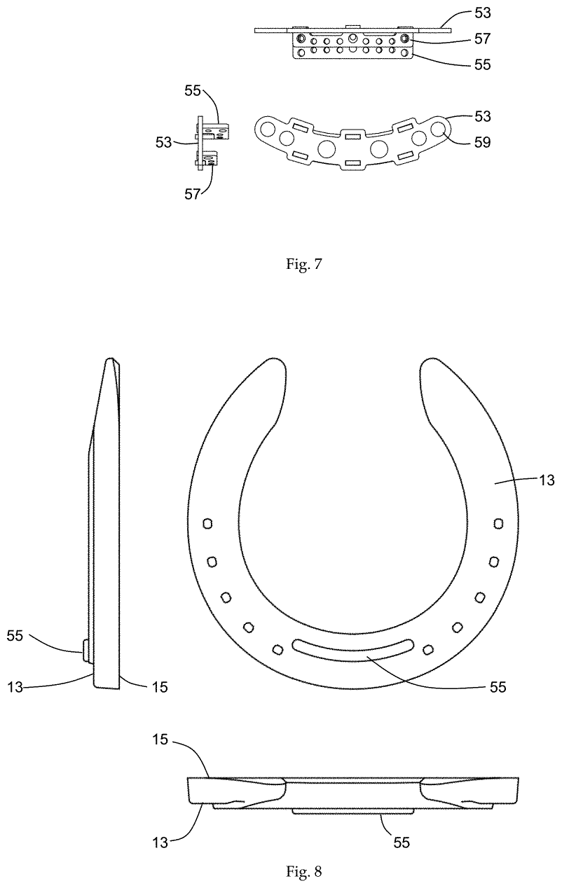

FIG. 6 and FIG. 7 show an abrasion protection 51 which can additionally be embedded with the reinforcing layers in the shoeing. The shape of the abrasion protection may be adapted overall to a central section of the shoeing and therefore has an overall curvature. The abrasion protection contains a base plate 53, on which two bars aligned parallel to one another, i.e. an inner or rear bar 55 and an outer or front bar 57, are fixed or integrally formed. The bars 55, 57 are designed as curved elongate plates, which makes up the abovementioned general curvature of the abrasion protection. Both bars 55, 57, are fixed on the base plate 53 essentially via one of their respective long edges in a perpendicular orientation to the latter. The base plate 53 is essentially designed as a flat plate. The edges of the base plate 53 can have a contour which is adapted to the curvature of the bars 55, 57, fixed on it in mutually parallel alignment. The base plate 55 and the bars 55, 57, are dimensioned in such a way that, embedded in the shoeing, the bars project on the running surface side from inside the shoeing approximately to the running surface 13 or project slightly beyond the latter. In particular for a shoeing with a profiled running surface, as shown in FIG. 3, the first and second bars may be designed to be of different heights. Expediently, at least the edge of the rear bar 57 projects beyond the running surface or the rear running surface rib 23, as shown in FIG. 8, for example by about 1 mm. This has the advantage that even a recently shoed horse immediately finds a satisfactory hold on the ground, because the surface of the composite material of the shoeing is slick and slippery at the beginning, before the surface roughens with use and offers better hold.

The base plate 53 of the abrasion protection device can be provided with holes 59 or other structures which permit the abrasion protection device 51 to be inserted and fixed in a cavity of a mold.

Reinforcing layers as well as bands or tubes are laid in the shoeing essentially above, below, in front of and behind the abrasion protection, so that the abrasion protection is integrated and fixed as well as possible in the shoeing. In particular, one, two or more reinforcing layers as well as bands or tubes between the two bars 55, 57 can be guided along the base plate 53, as a result of which the abrasion protection is integrated and fixed particularly well in the shoeing on the running surface side, in that at least one reinforcing layer or a reinforcing belt or reinforcing hose thereby runs in the shoeing between the base plate 53 of the abrasion protection and the shoeing running surface.

The invention is explained below with reference to an example.

### EXEMPLARY EMBODIMENTS

A method of producing a shoeing comprising at least the following successive steps:
Providing a tool mold (negative mold) having a U-shaped cavity in a substantially horizontal working surface, the cavity being open at the top and its U-shape being defined by inner contour walls. Insofar as the fitting to be produced is to have at least one furrow, the tool shape is equipped with a furrow recess contour, that is to say an elevation running in a U-shape centrally in the U-shaped cavity. Insofar as the fitting to be produced is to have recesses for hoof nails, the tool mold is equipped with a plurality of pin-like elevations which are distributed centrally in the U-shaped cavity on a U-shaped line and which rise from the cavity base of the groove elevation to the level of the working surface.
Optional use of an abrasion protection.
Inserting a plurality of flattened tubes (31, 33) or bands (31′, 33′) into the cavity in such a way that they follow the U-shaped curvature of the cavity in their longitudinal extension and are aligned essentially vertically (or upright) in their transverse extension. Insofar as a furrow recess contour is present in the tool shape, a first part of the plurality of flattened tubes (31) or bands (31′) is located on one side of the furrow recess contour and the second part of the plurality of flattened tubes (33) or bands (33′) is located on the other side of the furrow recess contour.
Optionally laying out one or more further flattened tubes (35) or bands (35′) in the tool shape over the previously vertically inserted plurality of flattened tubes (31, 33) or bands (31′, 33′) in such a way that the one or more further flattened tubes (35) or bands (35′) essentially follow the U-shaped curvature in their transverse extension laid out horizontally and, insofar as there are a plurality of these further tubes (35) or bands (35′) these are laid horizontally one on top of the other.
Closing the cavity by means of a cover which is pressed against the mold in a force-tight manner, for example by screwing the cover and the mold. This creates a cavity.
Creation of a vacuum by sucking off the air in the cavity of the closed mold.
Filling the cavity of the mold with a hardening plastic or plastic system, for example by the negative pressure produced as a result of the vacuum and, if appropriate, simultaneously applying an injection pressure, in order thereby to completely fill the U-shaped cavity equipped with tubes (31, 33, 35) or bands (31′, 33, 35) with the hardening plastic or plastic system and, in the process, to embed the tubes (31, 33, 35) or bands (31′, 33, 35) therein.
Curing of the plastic or plastic system, optionally at elevated temperature.
Cooling down and removing the shoeing from the mold.

In the production of shoeings, tubes can be inserted in a flattened manner, similar to the bands.

In another embodiment, meshed aramid tubes are used. Insofar as one or more horizontally designed tubes are also inserted, aramid tubes may likewise be employed for this purpose; alternatively, one or more carbon tubes can be used for this purpose. To produce the matrix, curable synthetic resin systems, such as, for example, curable epoxy resin systems or curable polyurethane resin systems, are used. For hardening, the shoeing may be kept or treated at a temperature of approximately 120° C. for approximately 1 hour. The tool shape used may be self-heating.

Maintaining an elevated temperature (i.e., a temperature elevated above room temperature) for a certain period of time during curing and/or thereafter can help reduce stresses in the material. This can lead to improved product quality.

The tool mold used is, in particular, self-heating in the sense that the temperature of the tool mold can be set to a specific value (for example to 120° C. as mentioned above) and can be maintained for a specific period of time (for example for 1 hour as mentioned above).

While specific embodiments have been described above, it is obvious that different combinations of the embodiments shown can be used, insofar as the embodiments are not mutually exclusive.

While the invention has been described above with reference to specific embodiments, it is obvious that changes, modifications, variations and combinations can be made without departing from the concept of the invention.

1. A shoeing for horses comprising:
a running surface and a hoof contact surface, the shoeing having a U-shaped curvature in a direction between the first end and the second end and comprised of a plastic matrix having a plurality of elongate reinforcing layers embedded therein, each of the elongate plurality of reinforcing layers having a longitudinal extent longitudinally extending along the U-shaped curvature of the shoeing and a transverse extent transversely extending from the running surface toward the hoof contact surface in a transverse direction of each of the elongate plurality of reinforcing layers.

2. The shoeing of claim 1, wherein the running surface further comprises at least two running surface ribs running next to one another and following the U-shaped curvature of the shoeing and between which a running surface groove runs, and in that the plurality of elongate reinforcing layers which extend essentially in each case transversely with respect to their longitudinal extent from the running surface towards the hoof contact surface are divided into at least one first group and a second group, at least one reinforcing layer of the first group penetrating into the first running surface rib in the matrix and at least one reinforcing layer of the second group penetrating into the second running surface rib in the matrix, with openings for hoof-fitting nails defined in the running surface groove.

3. The shoeing of claim 1, wherein one of the plurality of elongate reinforcing layers is arranged on a hoof contact surface side in such a way that it is aligned essentially parallel to the hoof contact surface, and in that the one of the plurality of elongate reinforcing layers aligned may be essentially parallel to the hoof contact surface or the uppermost one of the one of the plurality of elongate reinforcing layers is essentially parallel to the hoof contact surface and penetrates in the matrix essentially as far as below the hoof contact surface or forms the hoof contact surface.

4. The shoeing of claim 3, wherein, within the matrix, the plurality of elongate reinforcing layers, which extend transversely to their longitudinal extent, substantially from the running surface towards the hoof contact surface, are spaced apart from the hoof contact surface by the at least one reinforcing layer aligned parallel to the hoof contact surface.

5. The shoeing of claim 1, wherein the reinforcing layers comprise tube structures or band structures.

6. The shoeing of claim 1, wherein the reinforcing layers are formed essentially from fibers, flat fiber structures, a band structure, three-dimensional fiber structures, or a tubular structure.

7. The shoeing of claim 6, wherein the fibers or fiber structures comprise textile structures, meshes, woven fabrics, non-woven fabrics, knitted fabrics and/or knotted fabrics.

8. The shoeing of claim 7, wherein the fiber structures or textile structures, meshing, woven fabric, non-woven fabric, knitted fabric or knotted fabric are produced essentially from fiber strands.

9. The shoeing of 8, wherein the fibers or fiber strands are essentially long fibers or continuous fibers.

10. The shoeing of 6, wherein the fibers are selected from the group consisting of aramid fibers, carbon fibers, polymer fibers, glass fibers or combinations thereof.

11. The shoeing of claim 1, wherein the plastic matrix is essentially selected from cured plastic resin systems.

12. The shoeing of claim 1, further comprising an abrasion protection element embedded in the plastic matrix, the abrasion protection element rising at least partially from the plastic matrix on the running surface or the abrasion protection element having the form of two curved bars which are arranged next to one another, follow the U-shaped curvature of the shoeing and connected within the plastic matrix via a bridge.

13. The shoeing of claim 1, wherein the shoeing is produced by a vacuum pressing process.

14. A method of producing a shoeing, comprising:
providing at least one tool mold with a substantially flat working surface with a cavity configured in the shape of a horseshoe in a plane of the working surface is formed;
inserting into the cavity a plurality of reinforcing layers in their longitudinal extent following a U-shaped curvature of the cavity and aligned substantially perpendicularly to the working surface transversely to their longitudinal extent;
introducing a hardening plastic system into the cavity with the reinforcing layers.

15. The method of claim 14, further comprising, before introduction of the hardening of the plastic system into the cavity, closing a lid of the at least one tool mold, thereby forming a mold cavity.

16. The method of claim 15, further comprising evacuating the mold cavity.

17. The method of claim 15, further comprising introducing the hardening plastic system by negative pressure in the mold cavity, by applying an injection pressure or a combination of negative pressure in the mold cavity and by applying an injection pressure.

18. The method of claim 15, arranging pin-like elevations in the cavity, which elevations serve to form the nail holes in the shoeing to be manufactured.

19. The method of claim 15, further comprising inserting an abrasion-protection element into the cavity of the tool mold, a depression for receiving the abrasion-protection element preferably being formed in the cavity.

20. The method of claim 19, further comprising fixing the abrasion protection element in the cavity on at least one or two elevations.

21. A shoeing, comprising:
a running surface and a hoof contact surface, the shoeing being constructed from a plastic matrix in which a plurality of reinforcing layers are embedded, the reinforcing layers each having a longitudinal extent and the reinforcing layers being arranged in such a way that their respective longitudinal extent substantially follows the U-shaped curvature of the shoeing;
a plurality of the reinforcing layers arranged in such a way that they extend transversely to their longitudinal extent substantially in each case from the running surface to the hoof contact surface, in that at least one additional reinforcing layer is arranged on the hoof contact surface side in such a way that it is aligned essentially parallel to the hoof contact surface, and in that the reinforcing layer aligned essentially parallel to the hoof contact surface or the uppermost of the reinforcing layers aligned essentially parallel to the hoof contact surface penetrates in the matrix essentially as far as below the hoof contact surface or forms the hoof contact surface, and in that the reinforcing layers are present as textile tube structures, the textile tube structures being produced from fiber strands, wherein each fiber strand includes a plurality of fibers.
